(19) United States
(12) Patent Application Publication
(10) Pub. No.: US 2023/0266952 A1
(43) Pub. Date: Aug. 24, 2023

(54) SYSTEM AND METHOD FOR MULTI-SELECTION SOFTWARE PACKAGE FILE VALIDATION

(71) Applicant: Toshiba TEC Kabushiki Kaisha, Shinagawa-ku (JP)

(72) Inventor: Marianne KODIMER, Huntington Beach, CA (US)

(21) Appl. No.: 17/676,515

(22) Filed: Feb. 21, 2022

(51) Int. Cl. G06F 8/61; G06F 11/36; G06F 9/451

(52) U.S. Cl. CPC G06F 8/61; G06F 11/3612; G06F 9/451

(57) ABSTRACT

A system and method for generation, validation assembly and deployment of software packages provides validation as files are selected for inclusion. An web user interface employs a file browser that allows a user, from a single location, to select more than one file in succession from one or more location and while validating integrity of the single file and batch of files in combination, allowing the user to remove and add files until the set is valid to create a deployable single software package.

### TECHNICAL FIELD OF THE INVENTION

This application relates generally to creation of valid software packages for distribution. The application relates more particularly to creation of software packages, such as software packages for configuring multifunction peripherals, by selecting components from various locations while validating selections or combinations of selections as they are selected.

### BACKGROUND OF THE INVENTION

Document processing devices include printers, copiers, scanners and e-mail gateways. More recently, devices employing two or more of these functions are found in office environments. These devices are referred to as multifunction peripherals (MFPs) or multifunction devices (MFDs). As used herein. MFPs are understood to comprise printers, alone or in combination with other of the afore-noted functions. It is further understood that any suitable document processing device can be used.

Modern MFPs are complex devices that operate under a dedicated computer system referred to as an intelligent controller. The controller operates MFP functionality, including scanning, copying, printing and faxing. The controller also facilitates data exchange with networks or user devices. The controller also facilitates a user interface (UI), which may comprise generating a display and receiving user input, such as via a touchscreen. MFP functionality, including a user interface configuration, is controlled by software, which software may be deployed to an MFP via a software package.

### BRIEF DESCRIPTION OF THE DRAWINGS

Various embodiments will become better understood with regard to the following description, appended claims and accompanying drawings wherein:

FIG. 1 is an example embodiment of a system for multi-selection software package validation;

FIG. 2 is an example embodiment of a networked digital device, such as multifunction peripheral;

FIG. 3 is an example embodiment of a digital device system:

FIG. 4 is an expanded view of opening screen 124 from FIG. 1;

FIG. 5 is expanded view of file selection screen 132 of FIG. 1;

FIG. 6 is expanded view of file selection screen 132′ of FIG. 1;

FIG. 7 is an expanded view of selected file screen 148 of FIG. 1;

FIG. 8 is expanded view of valid file screen 152 of FIG. 1

FIG. 9 is an expanded view of package generation screen 160 of FIG. 1; and

FIG. 10 is a flowchart of an example embodiment of a system for multi-selection software package validation.

### DETAILED DESCRIPTION OF THE INVENTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Computer systems, such as MFP intelligent controllers, are software driven. Software installation or modification can be accomplished by loading a software package. A software package can be assembled from different modules or files prior to deployment. Files may be directed to areas such as generating and implementing a user interface, or functions such as scanning, printing, copying, faxing, emailing, scanning to email, or the like. Other files may control basic MFP functions such as scanner operation, printer operation, c-mail operation, fax operation and copy operation. Other files may provide specific functions such as scan-to-email, scan-to-folder. Files may also include firmware updates or fillable forms.

Packages can be assembled by users via a file browse dialog which allows the user to select single files, one at a time or bulk files if they are in the same folder location. Assembled file packages may be validated when browsing control is dismissed once file import is attempted. An assembled file package can fail validation for many reasons, including file type, file missing required information, file format, file size, file presence, file compatibility or file duplicity. Reasons for a package validation failure may not be apparent. And if reassembly is attempted to alleviate one problem, it may result in creation of a different problem.

Example embodiments herein provide an intuitive web UI whereby a file browse popup allows a user to select more than one file in succession from one or more location, in bulk from a single location, and while validating integrity of the single file and batch of files in combination, allowing the user to remove and add files until the set is valid to create a deployable single software package.

A file browser container allows the user to select one or more files individually, or in a set from the file system, and validates in real time allowing the user to see the invalid files, add requisite files in the set, and remove invalid files, before proceeding, to ensure a valid package creation. And the initial popup window instructs the user to browse for a file to be imported into the system. The file type requirements are stated and the only enabled button is the one that allows him/her to browse the file system. A web browser file browse control allows the user to select one or more files individually, or in a batch, so the system can validate the selected files individually, and as a set, locally in the UI allowing the user to see the invalid file(s) within the set and therefore correct the action before importing. Once files are selected from the operating system, they are validated before showing them in the popup window. If the file is invalid, a global error is displayed, and the corresponding erroneous files are shown color coded to the error message.

The user can remove one or more files from the set before importing; and the user must remove invalid files before continuing. If at least one file in the set is valid, an action button, such as import, is enabled allowing the valid file only to be imported. Thus, individual file validity is checked, and validity of the set is checked to ensure a valid package is created. If more than one error is detected, they are suitably presented sequentially so the user can remove or add to the package until the package is complete and valid.

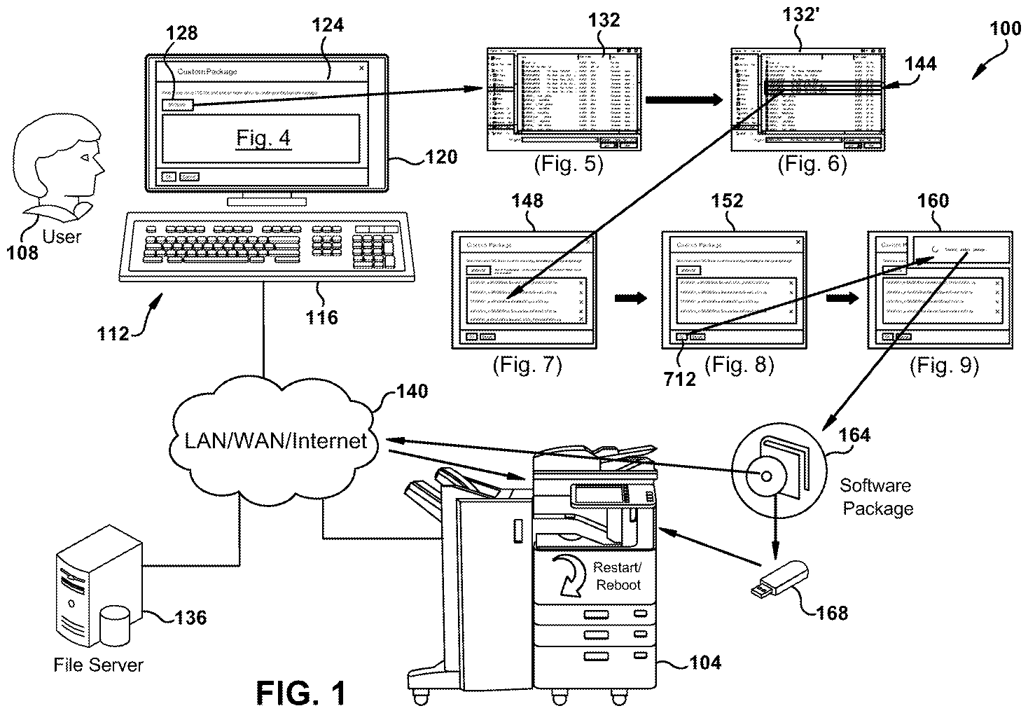

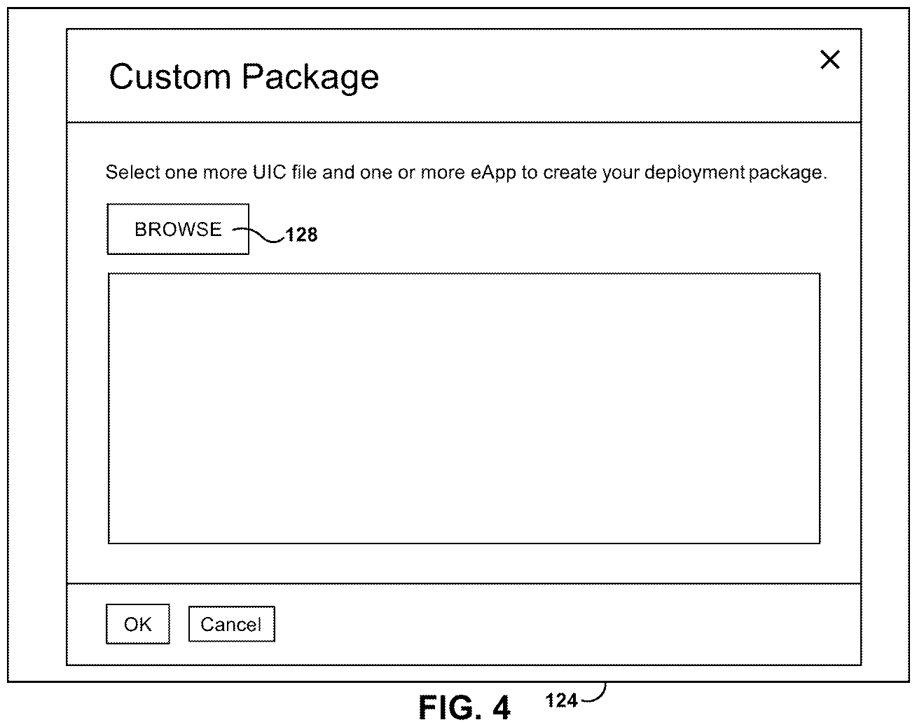

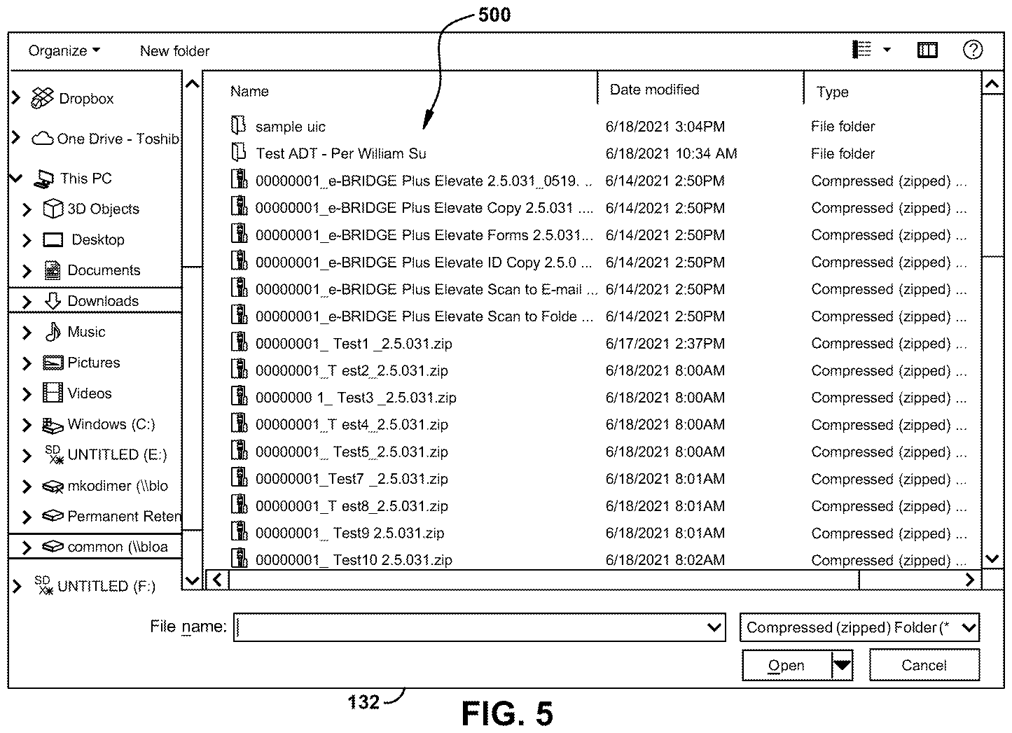

FIG. 1 illustrates an example embodiment of a system 100 for multi-selection software package validation. In the illustrated example, a software package is to be assembled and deployed to a digital device, such as MFP 104. Software assembly is directed by user 108 operating via their device, such as workstation 112. It is to be appreciated that any suitable digital device may be used, including notebook computers, smartphones or tablet computers. Workstation 112 includes a user input 116 and display 120. Software package assembly and deployment is commenced with opening screen 124, suitably by selection of browse button 128. An expanded view of opening screen 124 is provided with FIG. 4, below. Selection of browse button 128 brings up file selection screen 132. An expanded view of file selection screen 132 is provided with FIG. 5.

Files may be obtained from any suitable file location, such as locally on workstation 112 or remotely, such as from MFP 104 or fileserver 136. Device data communication in FIG. 1 is accomplished via network cloud 140, suitably comprised of a local area network (LAN), a wide area network (WAN), which may comprise the Internet, or any suitable combination thereof. Network cloud 140 is comprised of any suitable wireless or wired data connection or combination thereof.

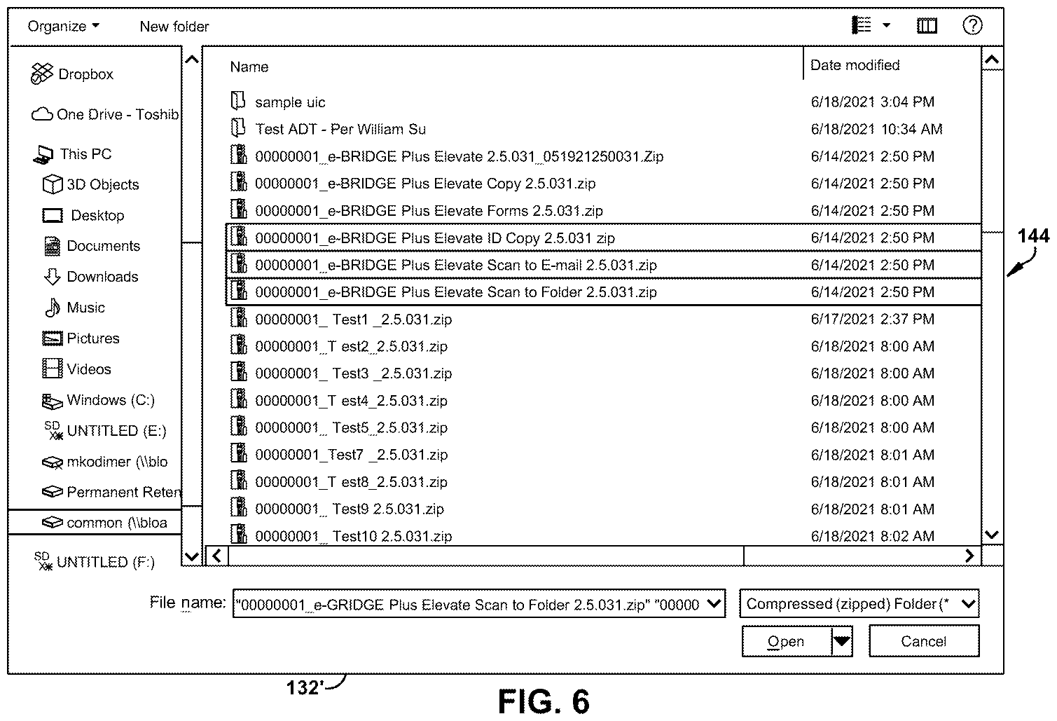

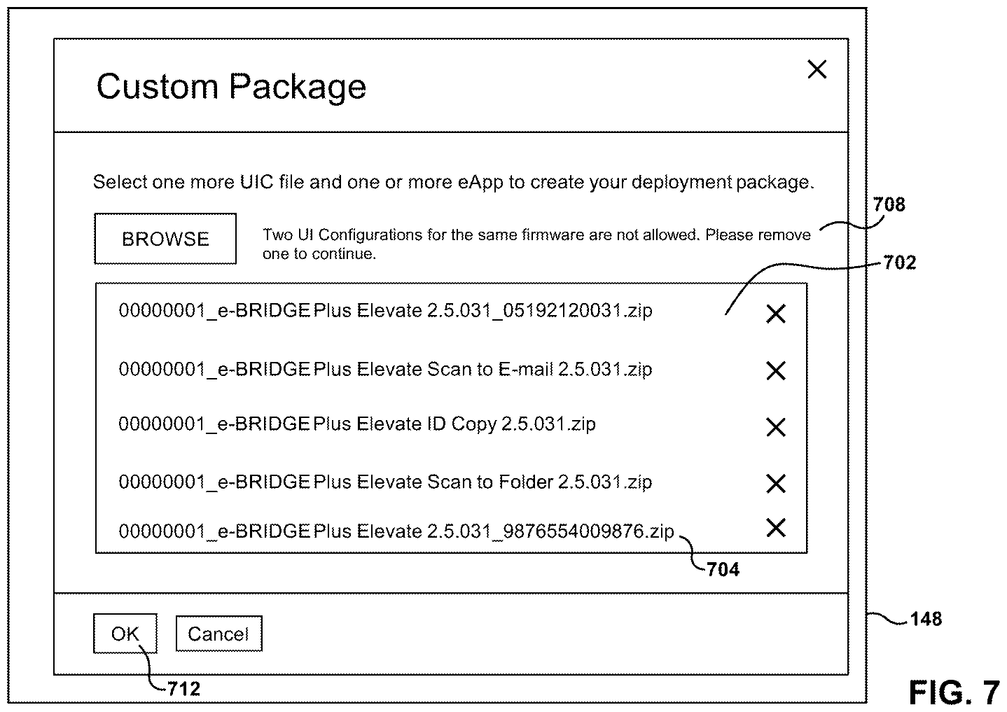

File selection screen 132′ shows selected files 144 taken from file selection screen 132. Selected files 144 are displayed on selected file screen 148, along with any error message that may result from file validation errors. An expanded view of file selection screen 132′ is provided with FIG. 6 and an expanded view of selected file screen 148 is provided with FIG. 7. Valid file screen 152 is generated once a valid file set has been obtained.

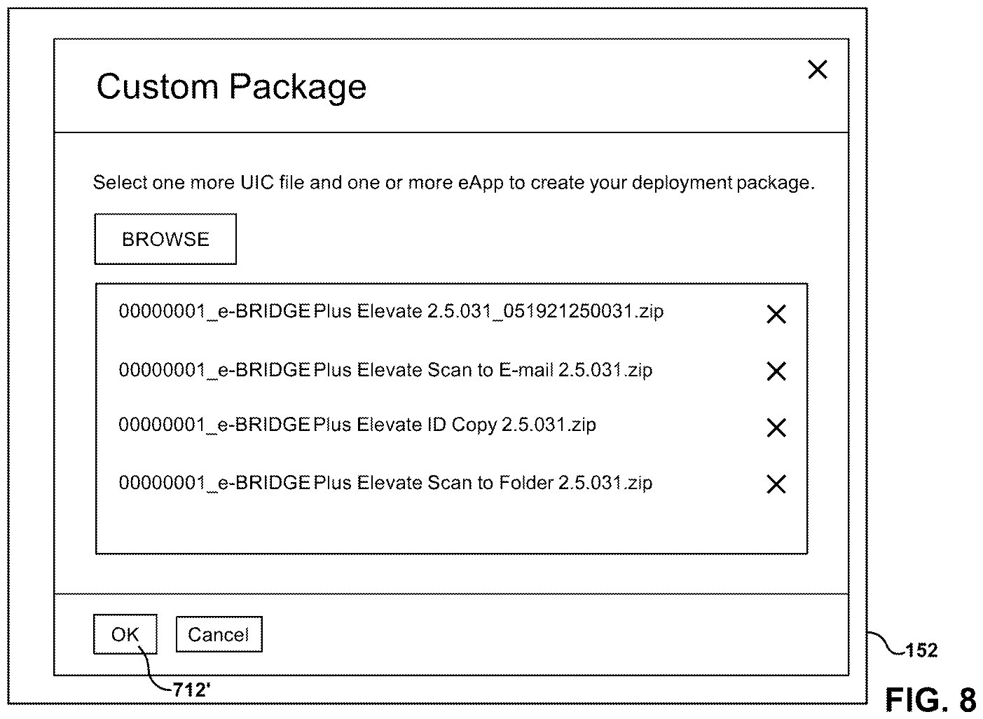

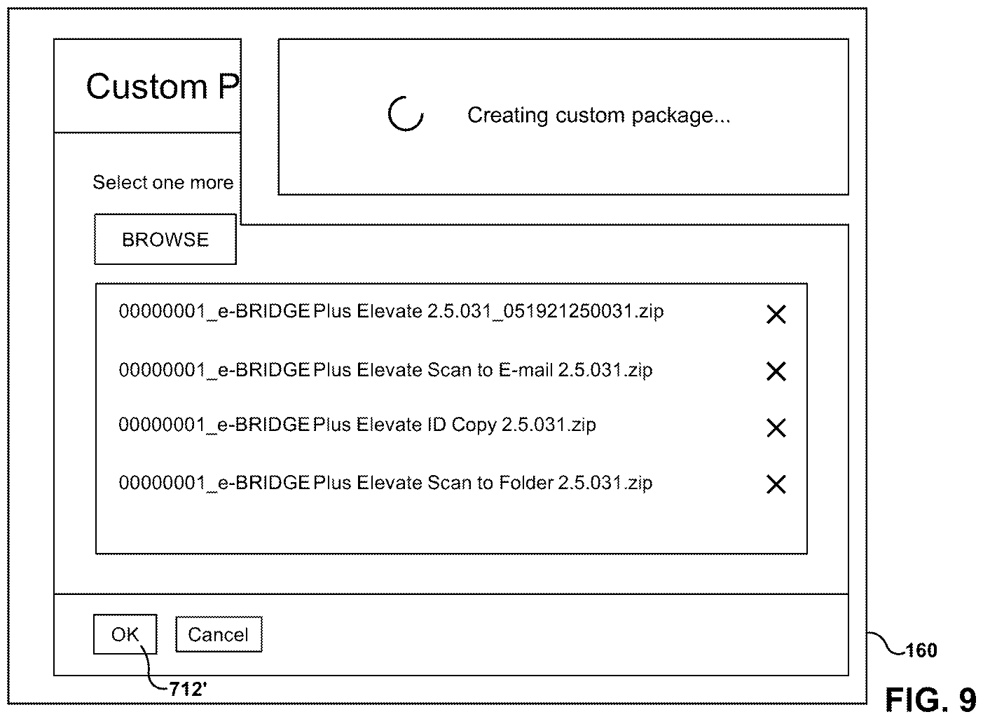

An expanded view of valid file screen 152 is provided with FIG. 8. Once a desired file package has been successfully assembled, an export button 712′ is enabled. Once button 712′ has been selected, export of the package generation is commenced as illustrated with package generation screen 160. An expanded view of package generation screen 160 is provided with FIG. 9. An assembled software package 164 is saved and communicated to a targeted device by any suitable means, such as via network cloud 140, or via any suitable non-transitory computer-readable medium such as memory fob 168. Once deployed, a device suitably installs the package, and when installed, may commence a device restart or reboot to implement it.

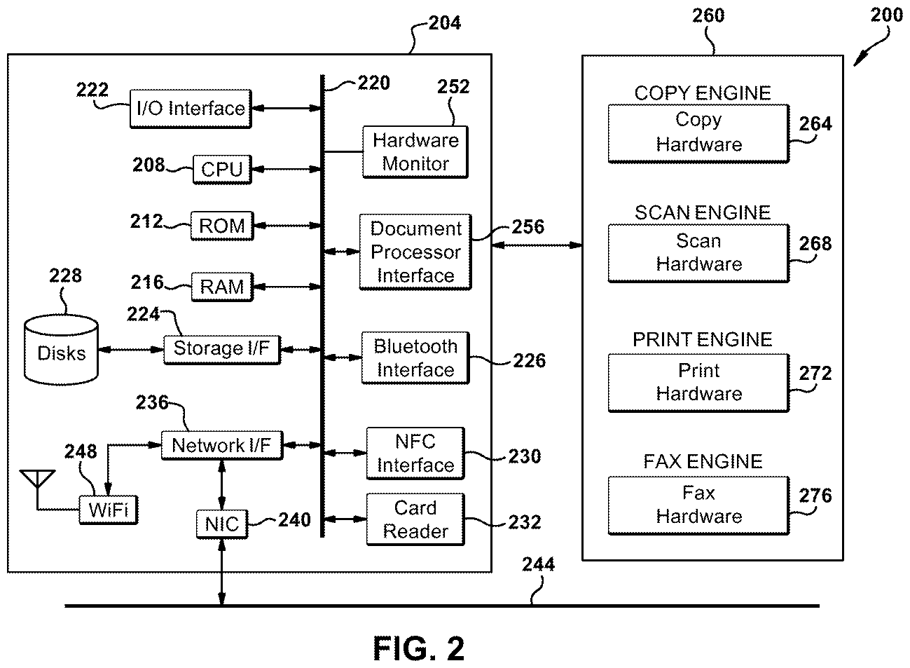

Turning now to FIG. 2, illustrated is an example embodiment of a networked digital device comprised of document rendering system 200 suitably comprised within an MFP, such as with MFP 104 of FIG. 1. It will be appreciated that an MFP includes an intelligent controller 204 which is itself a computer system. Thus, an MFP can itself function as a server with the capabilities described herein. Included in intelligent controller 204 are one or more processors, such as that illustrated by processor (CPU) 208. Each processor is suitably associated with non-volatile memory, such as read-only memory (ROM) 212, and random access memory (RAM) 216, via a data bus 220.

Processor 208 is also in data communication with input/output interface 222, suitably comprising a user touchscreen. While touchscreens are discussed in example embodiments herein, it is to be appreciated that any suitable user interface, such as keyboards, switches, displays, trackballs or mice may be used.

Processor 208 is also in data communication with a storage interface 224 for reading or writing to a storage 228, suitably comprised of a hard disk, optical disk, solid-state disk, cloud-based storage, or any other suitable data storage as will be appreciated by one of ordinary skill in the art.

Processor 208 is also in data communication with additional interfaces, such as Bluetooth interface 226, NFC interface 230 and card reader 232 for data exchange with proximity cards, such as card keys.

Processor 208 is also in data communication with a network interface 236 which provides an interface to a network interface controller (NIC) 240, which in turn provides a data path to any suitable wired interface or physical network connection 244, or to a wireless data connection via wireless network interface 248. Example wireless network interfaces include optical, cellular, Wi-Fi, wireless universal serial bus (wireless USB), satellite, and the like. Example wired interfaces include Ethernet, USB, IEEE 1394 (FireWire), Lightning, telephone line, or the like.

Processor 208 can also be in data communication with any suitable user input/output (110) network interface 222 which provides data communication for interfacing with user peripherals, such as displays, keyboards, mice, track balls, touch screens, or the like. Processor 208 can also be in communication with hardware monitor 252, such as a page counter, temperature sensor, toner or ink level sensor, paper level sensor, or the like.

Also in data communication with data bus 220 is a document processor interface 256 suitable for data communication with the document rendering system 260, including MFP functional units. In the illustrated example, these units include a scan engine comprising copy hardware 264, a scan engine comprise of scan hardware 268, a print engine comprised of print hardware 272 and a fax engine comprised of fax hardware 276 which together comprise document rendering system 260. It will be understood that functional units are suitably comprised of intelligent units, including any suitable hardware or software platform.

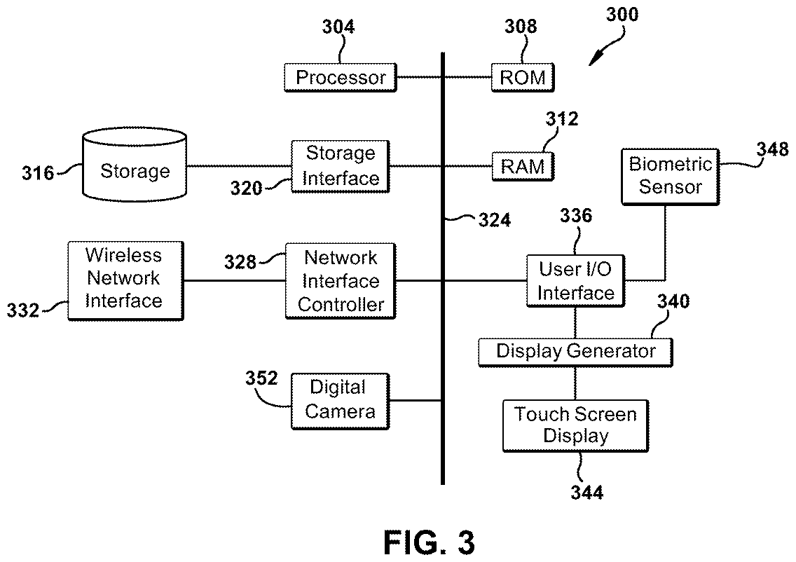

Turning now to FIG. 3, illustrated is an example embodiment of a digital data processing device 300 such as workstation 112 or user input 116 of FIG. 1. It is to be appreciated that some components listed may be unnecessary in certain configurations. Components of the digital data processing device 300 suitably include one or more processors, illustrated by processor 304, memory, suitably comprised of read-only memory 308 and random access memory 312, and bulk or other non-volatile storage 316, suitably connected via a storage interface 320. Data communication among components is accomplished via data bus 324. A network interface controller 328 suitably provides a gateway for data communication with other devices, via any wireless or wired connection, such as via wireless network interface 332. A user input/output interface 336 is suitably comprised of display generator 340 interfacing with touchscreen display 344. As noted above, any suitable user input and display can be used. User input/output interface 336 also provides connection to biometric sensor 348, suitably comprised of a fingerprint sensor, retinal sensor, or the like, and may be used to secure device access to one or more users. Processor 304 processor is also in data communication with a digital camera 352, suitably used to capture images which may include encoded images such as barcodes or QR codes. Digital camera 352 is also suitably used for facial recognition, including facial recognition for securing device access.

FIG. 4 is an expanded view of opening screen 124 from FIG. 1. Creation of a custom software deployment package is commenced with opening screen 124, suitably by user selection of browse button 128.

FIG. 5 is an expanded view of file selection screen 132 of FIG. 1 illustrating selectable files, folders, devices and file locations for assembly of a software package. FIG. 6 is an expanded view of file selection screen 132′ of FIG. 1 showing selected files 144 that have been selected by a user from file selection screen 132.

FIG. 7 is an expanded view of selected file screen 148 of FIG. 1 showing that two of the user selected files, files 702 and 704 are invalid or erroneous. These files are suitably marked, such as via coloration, bolding, or the like, to show that they are problematic. A warning message 708 explains why validation failed during assembly. A user can delete files or add additional files to remedy the problem. Button 712 can be an export button which enables generation or export of a software package is disabled or grayed out while errors remain.

FIG. 8 is an expanded view of valid file screen 152 of FIG. 1 wherein all assembled files have been validated. No error message is displayed and generation or export is enabled as illustrated by button 712′.

FIG. 9 is an expanded view of package generation screen 160 of FIG. 1 showing creation of a software package after user selection of button 712′.

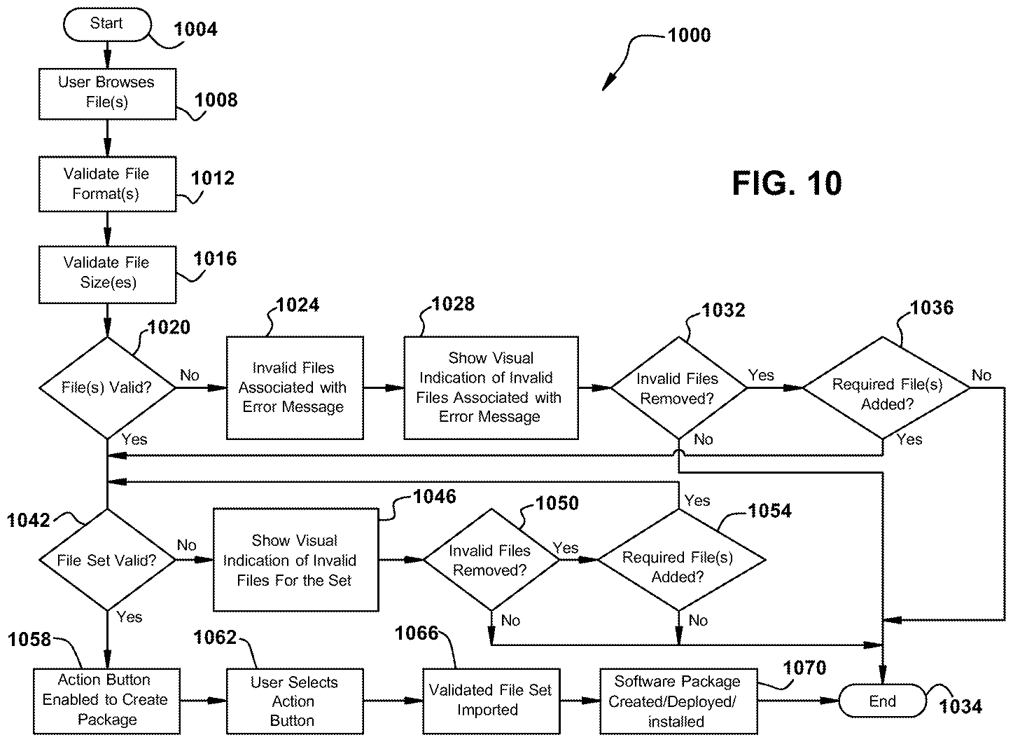

FIG. 10 illustrates a flowchart 1000 of an example embodiment of a system for multi-selection software package validation. The process commences at block 1004 and proceeds to block 1008 where a user browses and selects files desired for a software package. The selected files are validated for formatting at block 1012 and file size at block 1016. A test is made at block 1020 for file validity. Any invalidity causes the process to proceed to block 1024 where each invalid file is associated with an error message. A visual indication of invalid files and associated error messages is shown to the user at block 1028. A test is made at block 1032 as to whether invalid files have been removed. If not, the process ends at block 1034.

If invalid files are determined to be removed at block 1032, the process proceeds to block 1036 at which point required files can be addes and the validity of the file set is tested at block 1042. If the file set is determined to be invalid, progress is made to block 1046 where a visual indication of invalid files for the set is shown to the user. A test is then made at block 1050 as to whether invalid files have been removed. If not, the process ends at block 1034. When invalid files have been removed, progress is made to block 1054 to verify whether any necessary files have been added. If not, the process ends at block 1034. If so, the probes returns to block 1042 until all rile sets have been validated, alone or in combination.

Once all validations are complete at block 1042, the export or assembly button is enabled at block 1058, and the user selects it at block 1062. A validated file set is imported at block 1066. A software package is created, deployed and/or installed at block 1070.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a processor and associated memory;
a data interface;
a user interface including a user input and a display;
the processor configured to show, in a first window on the display, selectable electronic file indicia corresponding to a first plurality of electronic files in a first storage location;
the processor further configured to receive a first user selection of the first plurality of electronic files from the first storage location via the user input;
the processor further configured to validate the first plurality of electronic files;
the processor further configured to show one or more first validation errors corresponding to the first plurality of electronic files;
the processor further configured to receive a first updated user selection of the first plurality of electronic files responsive to the one or more first validation errors to generate a first validated file set;
the processor further configured to show, in a second window on the display, selectable electronic file indicia corresponding to a second plurality of electronic files in a second storage location;
the processor further configured to receive a second user selection of the second plurality of electronic files from the second storage location via the user input;
the processor further configured to validate the second plurality of electronic files;
the processor further configured to show one or more second validation errors corresponding to the second plurality of electronic files;
the processor further configured to receive a second updated user selection of the second plurality of electronic files responsive to the one or more second validation errors to generate a second validated file set;
the processor further configured to validate the first validated file set relative to the second validated file set;
the processor further configured to show the one or more first validation errors associated with validation of the first validated file set relative to the second validated file set;
the processor further configured to receive an updated selection of electronic files from a first validated subset or a second validated subset responsive to validation of the first validated file set relative to the second validated file set;
the processor further configured to generate a software package from the updated selection of electronic files; and
the processor further configured to communicate the software package to a digital data device for installation via the data interface comprised of a network interface or a tangible medium.

2. The system of claim 1 wherein one or both of the first storage location and the second storage location are accessed via the network interface.

3. The system of claim 1 wherein validation is comprised of validation of one or more of file format, rile size, file presence and file compatibility.

4. The system of claim 3 wherein the one or more first validation errors are shown with a message specifying a file format error, file size error, a rile presence error or a fie compatibility error.

5. The system of claim 4 wherein the processor is further configured to enable generation of the software package when no validation errors are present in the updated selection of electronic files and disable the generation of the software package when the one or more first validation errors are present in the updated selection of electronic files.

6. The system of claim 5 wherein validation is further comprised of a determination of file duplicity and wherein the one or more first validation errors are shown with a message specifying file duplicity.

7. The system of claim 6 wherein file duplicity is associated with files having different software versions, different firmware versions or different user interfaces.

8. A method comprising:
showing via a processor in a first window on a display, selectable electronic file indicia corresponding electronic files in a first storage location;
receiving a first user selection of a first plurality of electronic files from the first storage location via a user input;
validating, via the processor, the first plurality of electronic files;
showing on the display, via the processor, one or more validation errors corresponding to a validated first plurality of electronic files;
receiving a first updated user selection of the first plurality of electronic files responsive to the one or more validation errors via the user input to generate a first validated file set;
showing, via the processor in a second window on the display, selectable electronic file indicia corresponding to a second plurality of electronic files in a second storage location when the first plurality of electronic files is validated;
receiving a second user selection of the second plurality of electronic files from the second storage location via the user input;
validating, via the processor, the second plurality of electronic files;
showing, on the display via the processor, the one or more validation errors corresponding to a validated second plurality of electronic files;
receiving an updated user selection of the second plurality of electronic files responsive to the one or more validation errors via the user input to generate a second validated file set;
validating, via the processor, the first validated file set relative to the second validated file set;
showing, via the processor on the display, the one or more validation errors associated with validation of the first validated file set relative to the second validated file set;
receiving an updated selection of electronic files from a first validated subset or a second validated subset via the user input responsive to validation of the first validated file set relative to the second validated file set;
generating, via the processor, a software package from the updated selection of electronic files; and
communicating, via the processor, the software package to a digital data device for installation via a data interface comprised of a network interface or a tangible medium.

9. The method of claim 8 wherein one or both of the first storage location and the second storage location are accessed via the network interface.

10. The method of claim 8 further comprising validating of one or more of file format, file size, file presence and file compatibility.

11. The method of claim 10 further comprising showing a validation error with a message specifying a file format error, file size error, a file presence error or a file compatibility error.

12. The method of claim 11 further comprising generating the software package when no validation errors are present in the updated selection of electronic files and disable generation of the software package when the one or more validation errors are present in the updated selection of electronic files.

13. The method of claim 12 further comprising determining, via the processor, file duplicity and wherein the one or more validation errors are shown with a message specifying file duplicity.

14. The method of claim 13 wherein the file duplicity is associated with different software versions, different firmware versions or different user interfaces.

15. A non-transitory computer-readable medium for generating software packages comprising instructions stored thereon, that when executed on a processor, perform the steps of:
showing in a first window on a display, selectable electronic file indicia corresponding electronic files in a first storage location;
receiving a first user selection of a first plurality of electronic files from the first storage location via a user input;
validating the first plurality of electronic files;
showing on the display, one or more first validation errors corresponding to a validated first plurality of electronic files;
receiving an updated user selection of the first plurality of electronic files responsive to the one or more first validation errors via the user input to generate a first validated file set;
showing, in a second window on the display, selectable electronic file indicia corresponding to a second plurality of electronic files in a second storage location when the first plurality of electronic files is validated;
receiving a second user selection of the second plurality of electronic files from the second storage location via the user input;
validating the second plurality of electronic files;
showing, on the display, one or more second validation errors corresponding to a validated second plurality of electronic files;
receiving a second updated user selection of the second plurality of electronic files responsive to the one or more second validation errors via the user input to generate a second validated file set;
validating the first validated file set relative to the second validated file set;
showing, on the display, the one or more first validation errors associated with validation of the first validated file set relative to the second validated file set;
receiving an updated selection of electronic files from a first validated subset or a second validated subset via the user input responsive to validation of the first validated file set relative to the second validated file set;
generating a software package from the updated selection of electronic files; and
communicating the software package to a digital data device for installation via a data interface comprised of a network interface or a tangible medium.

16. The non-transitory computer-readable medium for generating software packages of claim 15 further comprising validating instructions for validating of one or more of file format, file size, file presence and file compatibility.

17. The non-transitory computer-readable medium for generating software packages of claim 16 wherein the validating instructions further comprise showing a validation error with a message specifying a file format error, file size error, a file presence error or a file compatibility error.

18. The non-transitory computer-readable medium for generating software packages of claim 17 wherein the validating instructions further comprise generating a software package when no validation errors are present in an updated selection of electronic files and disable generation of the software package when one or more validation errors are present in the updated selection of electronic files.

19. The non-transitory computer-readable medium for generating software packages of claim 18 wherein the validating instructions further comprise determining file duplicity and wherein the one or more first validation errors are shown with a message specifying file duplicity.

20. The non-transitory computer-readable medium for generating software packages of claim 18 wherein file duplicity is associated with files having different software versions, different firmware versions or different user interfaces.
